(19) United States
(12) Patent Application Publication
(10) Pub. No.: US 2024/0193906 A1
(43) Pub. Date: Jun. 13, 2024

(54) METHOD FOR PROVIDING A DIGITAL IDENTIFIER FOR A WORKPIECE, ELECTRONIC DATABASE, TOKEN, AND DEVICE FOR GENERATING A TOKEN

(71) Applicant: Senodis Technologies GmbH, Dresden (DE)

(72) Inventors: Björn Erik MAI, Dresden (DE); Marek RJELKA, Senftenberg (DE); Christoph KROH, Dresden (DE)

(21) Appl. No.: 18/286,259

(22) PCT Filed: Apr. 8, 2022
(86) PCT No.: PCT/DE2022/100270

§ 371 Date: Oct. 10, 2023

(30) Foreign Application Priority Data
Apr. 12, 2021 (DE) 10 2021 109 020.2

(51) Int. Cl. G06V 10/44; G06K 7/14; G06V 10/60

(52) U.S. Cl. CPC G06V 10/44; G06K 7/1404; G06V 10/60

(57) ABSTRACT

A method for providing a digital identifier for a workpiece including: providing a workpiece on which a marking with marking elements is arranged that display an readable content and have marking element features formed separately; capturing an image using an image capturing device, the image at least partly displaying the marking; determining at least one marking element feature for one or more of the marking elements, wherein digital image data for the image is analyzed in the process; generating feature data which displays the at least one marking element feature; determining a digital identifier for the workpiece from marking data which includes the feature data; and storing the digital identifier as the identifier assigned to the workpiece in an electronic storage device. Also provided is an electronic database for electronically registering and tracking workpieces with digital identifiers, to a token, and to a device for generating a token.

### CROSS-REFERENCE TO RELATED APPLICATIONS

This application claims priority to PCT Application No. PCT/DE2022/100270, having a filing date of Apr. 8, 2022, which is based on DE Application No. 10 2021 109 020.2, having a filing date of Apr. 12, 2021, the entire contents both of which are hereby incorporated by reference.

### FIELD OF TECHNOLOGY

The following relates to a method for providing a digital identifier for a workpiece, an electronic database for electronically registering and tracking workpieces, a token, and a device for generating a token.

### BACKGROUND

Such technology is utilized in order to provide a traceability for any desired workpiece by electronic or digital markings, in particular for production or manufacturing processes.

In the manufacturing industry and especially in the metal sector, there is a high cost pressure in order to be able to offer products competitively. This cost pressure is exacerbated by regulatory conditions such as the reduction of CO₂ emissions and the circular economy. Digital optimization of production processes and supply chains is an option for the reduction of costs. There is a lack of consistent and unique IDs and identification standards for components, semi-finished products and products in order to enable the digital connectivity of individual participants in the value-creation networks and a tracking or exchange of information linked to these components, semi-finished products and products.

Information regarding components, semi-finished products and products is currently collected, stored and used within individual production steps. Multiple, non-interlinked component IDs are used for this purpose up to the final product. Multiple identification solutions with different standards are thus employed on the way from the raw material to the final product. If a tracking or exchange of information of the components, semi-finished products and products is possible, it is only on a case-by-case basis via manual inquiries.

A method and a system for identifying at least one component without using markings as well as for tracking components in a production process are known from the document DE 10 2017 001 915 A1. Disclosed are a method and a system for identifying at least one component without using markings, by capturing the optical surface structure of at least a part of the component as an image by an image processing system and ascertaining the unique, characteristic, optical surface features of the component, and generating a digital signature as a unique identification of the component and storing the same as a reference of the identification of at least one part of the component in an electronic data processing system. The captured image of the at least one part of the component is at least partially masked here for identification areas to be examined, and a number of the unique, characteristic, optical surface features of the component are extracted and determined from the image data of the at least partially masked image of the at least one part of the component via corresponding feature vectors. From the extracted number of intrinsic surface features of the masked image of the part of the component, the signature of the latter, which forms the unique identification of the part of the component, is created by customized predetermined software algorithms and is stored as a reference of the unique identification in the data processing system.

The document WO 2010/112614 A1 discloses a method for identifying an object, which provides the following: ascertaining unique, characteristic, optical features of the object and storing the ascertained features as an identifier of the object. The optical surface structure of the object is ascertained as a unique, characteristic, optical feature. Images or pictures are captured to this end. By the described method, the additional application of a marking on the object is meant to be omitted.

### SUMMARY

An aspect relates to a method for providing a digital identifier for a workpiece, which enables a specific identification of the workpiece by electronic data in an electronic memory in a simple and reliable manner. It is further intended to provide an electronic database for electronically registering and tracking workpieces as well as a token.

According to an aspect, a method for providing a digital identifier for a workpiece is provided, which comprises the following: providing a workpiece on which a marking comprising marking elements is arranged, which display an optically readable marking content and comprise marking element features formed separately from the marking content; capturing an image by an imaging device, wherein the image shows the marking at least in sections; determining at least one marking element feature for one or more of the marking elements, wherein to this end digital image data are evaluated for the image; generating feature data indicating the at least one marking element feature; determining a digital identifier for the workpiece from marking data comprising the feature data; and storing the digital identifier as an identifier associated with the workpiece in an electronic memory.

According to a further aspect, an electronic database for electronically registering and tracking workpieces is provided, which comprises digital identifiers that are electronically stored in a database storage element, are respectively associated with a workpiece and have been determined according to embodiments of the method. Moreover, a token with a digital identifier that is associated with a workpiece and that has been determined according to embodiments of the method is provided.

A device for generating a token (token generator) is also provided, which comprises one or more processors that are configured to generate a token with a digital identifier.

The proposed technology makes it possible to store or register any desired workpiece in an electronic memory, for example in a database that can be part of a network, by the digital or electronic identifier, which constitutes a unique digital or electronic ID for the workpiece. The electronic memory can be part of a distributed platform, for example in a network. The digital identifier associated with the workpiece can be stored and provided not just in one but in a plurality of electronic memories and is thus available as a specific digital ID for the workpiece.

For the determination of the digital identifier, one or more marking element features for marking elements of the marking are used, wherein the marking element features are formed separately from the actual marking content of the marking, i.e., they do not have to be evaluated in order to optically read the marking content of the marking on the workpiece. The marking element features are redundant with respect to the optical readability of the marking content. This means that the marking content is optically readable independently of the marking element features. The marking element features of the marking elements form additional, optionally random features or characteristics of the marking elements (over and above the marking content) that are determined through the capture of the image and the subsequent image data analysis and are used to generate the feature data, which for their part are then part of the marking data from which the digital identifier for the workpiece is determined in order to store the same in the electronic memory.

The steps for determining the digital identifier can be carried out before, during and/or after a production or manufacturing process for the workpiece. The capture of the image(s) by the imaging device can be carried out before and/or after the application of the marking on the workpiece. Determining the digital identifier before and/or during the production or manufacturing process has the advantage that the digital identifier is thus already available during this process, for example for identifying the workpiece in different stations of the production or manufacturing process. Multiple determinations or a repeated determination of the digital identifier can be provided.

A workpiece is a single delimited part of largely solid material that undergoes or has undergone some form of processing. The processing method itself is irrelevant. A workpiece can also be understood to be a single component and an already (partially) assembled assembly.

The digital identifier can be stored in the electronic memory in any form, whether encrypted or unencrypted.

During the determination of the at least one marking element feature, an error feature can be determined, which is an actual feature that deviates from a target feature for the one or more marking elements. This target feature should be formed accordingly when the marking is produced on the workpiece. That said, such target features are frequently only partially met, so that a deviation exists for individual target features according to an actual feature. Such deviations (also errors or defects) can be captured and determined optically during the determination of the at least one marking element feature. The deviations or errors here can lie within error tolerances that still guarantee the optical readability or evaluability of the marking content, whether only in parts or completely. The error features can be formed so as not to hinder, i.e., so as to allow, the complete optical readability of the marking content.

The error feature can indicate at least one deviation from the following group: deviation of a marking element position from a target position; deviation of a marking element shape from a target shape; deviation of a marking element size from a target size; deviation of a marking element brightness from a target brightness; deviation of a marking element contrast from a target contrast; deviation of a marking element spacing from a target spacing; and deviation of a relative marking element position in relation to another marking element and/or an arrangement grid from a relative target position. One or more of the deviations can occur, for example, when the marking elements of the marking are applied to the workpiece by paint. A label produced in advance and then applied adhesively to the workpiece can also comprise, however, one or more of the deviations that can be extracted or evaluated in the scope of the determination of the error feature. The deviations can be formed for different workpieces of a random distribution, which supports the individualizing design of the digital identifier.

The digital identifier can be determined as a checksum of the marking data. Basically, a checksum is a value that is calculated from source data, in this case marking data, and allows a comparison with a comparison checksum in order to establish whether the source data and the data used to calculate the comparison checksum are the same or different.

The checksum can be determined as a hash value of the marking data. The hash function for the mapping of the marking data to a hash value can be configured to map similar marking data to similar hash values. As optionally only the hash value is stored in the database, it is not possible to draw inferences regarding the marking data by the hash value alone, at least in this case. The similarity-sensitive property of the hash function also ensures that the similarity search can be carried out in the image space of the hash function itself and error bounds in the space of the marking data are transferred linearly into the metric image space of the hash function.

The digital identifier can be determined for the workpiece from marking data comprising content data that at least partially indicates the optically readable marking content. In this example embodiment, it is provided that the marking data comprise not only the feature data, but additionally content data that partially or completely indicate the optically readable marking content of the marking on the workpiece. An extended digital identifier is provided for the workpiece this way. The marking content can be determined when the digital image data for the image is analyzed or evaluated. Alternatively or additionally, the marking on the workpiece can be optically read out separately in order to determine the marking content.

The following can also be provided: determining at least one workpiece feature for an area outside the marking on the workpiece, wherein to this end the digital image data for the image and/or further digital image data for a further image are evaluated; generating workpiece feature data that indicate the at least one workpiece feature; and determining the digital identifier for the workpiece from marking data comprising the workpiece feature data. In this example embodiment, one or more workpiece features are additionally determined for the workpiece from the digital image data in order to then generate workpiece feature data for the same that indicate the one or more workpiece features, so that the marking data comprising at least the feature data can be supplemented by the workpiece feature data in order to determine an extended digital identifier for the workpiece.

For the determination of the one or more workpiece features, the image that was evaluated for the determination of the marking element feature can be used. Alternatively or additionally, a further image can be evaluated by digital image analysis in order to extract the workpiece feature. The one or more images show at least the area of the workpiece outside the marking for which the one or more workpiece features are determined. These are optically representable or determinable workpiece features, in particular features on the side of the surface of the workpiece, which can be determined using image analysis. For example, a surface contour or texture can be analyzed in an area adjacent to or spaced apart from the marking on the workpiece. Basically, workpiece features in any area or section of the workpiece, in particular outside the marking, can be used to determine the workpiece feature. The incorporation of the at least one workpiece feature in the generation and determination of the digital identifier for the workpiece facilitates a further individualization and improved uniqueness of the digital identifier for the workpiece.

It is possible for a workpiece from the following group to be provided as a workpiece: blank, processed blank, component, component group, metal component, processed component, processed component group, processed metal component, semi-finished material, semi-finished product, sub-assemblies, assembly group, assembly part, moulding, finished component and finished assembly.

The image can be captured after the workpiece provided with the marking has been processed according to at least one processing step. This can involve any processing step, for example a metalworking step in which the workpiece is heated or tempered. The marking can be designed as a temperature-stable marking.

In embodiments, the digital identifier can be determined and stored in the described manner multiple times during a production or manufacturing process. If a new determination of the digital identifier occurs, the digital identifier determined on this occasion can be compared with a previously determined digital identifier, for example also within the scope of a check whether the marking on the workpiece still possesses an identification effect to a sufficient degree and was not damaged during processing of the workpiece in such a manner that the digital identifier can no longer be determined correctly.

A workpiece can be provided with a marking comprising a data matrix code, wherein modules of the data matrix code form the marking elements. The data matrix code can be a one-dimensional code (for example bar code) or a two-dimensional code. Three-dimensional data matrix codes with colour design can also be employed. Various embodiments of data matrix codes are known per se. Modules form marking elements of the data matrix code, for example in the form of bars or dots. The marking element features can be determined for these modules and used for the generation and determination of the digital identifier.

In embodiments, multiple marking element features can be determined and taken into account in the generation of the digital identifier.

The provision of the workpiece can comprise an application of the marking to the workpiece, wherein the marking elements are produced using at least one marking method from the following group: ink printing, laser engraving, needle embossing, applying a label, applying marker elements such as magnetic particles, (light) emitting particles or the like, mechanical engraving, stamping processes, screen printing, coatings and plotting.

The marking can be applied as a temperature-resistant or heat-resistant marking, so that in particular processing steps are possible for the workpiece in which at least the area with the marking on the workpiece is heated or tempered.

In embodiments, the method can further comprise the following: storing workpiece data associated with the digital identifier for the workpiece in the electronic memory; receiving a request to access the workpiece data in an access device capable of accessing data in the electronic memory, wherein indicator data indicating a digital request identifier is received with the request; checking whether the digital request identifier matches the digital indicator; and granting the requested access to the workpiece data if it is established that the digital request identifier matches the digital identifier within a specified error tolerance.

The workpiece data can be any electronic information relating to the workpiece, for example material of the workpiece, serial number of the workpiece, date of manufacture, etc. The workpiece data can be partially comprised by the marking content. The workpiece data is stored associated with the digital identifier in the electronic memory, for example a database, so that access to the workpiece data is rendered possible and is controllable by the digital identifier. To block an unauthorized accessing of the workpiece data, the digital request identifier transmitted when access is requested is checked. Access to the workpiece data is only granted if a match is established for the digital request identifier and the (stored) digital identifier. In this respect, the digital identifier forms a kind of (software) token that allows a user to access the workpiece data in the electronic memory if the user is in possession of the token (digital identifier). In a variant, it is possible here to provide a two-factor authentication as known per se in different forms.

For the check, a match of a digital request identifier with a digital indicator can be determined if there is a similarity within a specified error tolerance.

If n (n>2) different marking element features were determined for the determination of the digital identifier and used to generate the digital identifier, it can be established by the error tolerance, for example, for how many of the n marking element features a match must be established in order for the request identifier and digital identifier to be determined to match.

In order to avoid having to use the marking element features themselves for this purpose, which features would allow the marking, for example the data matrix code, to be inferred, it can be provided that the similarity search is not to be carried out on the marking elements themselves. The marking element features can be mapped by a similarity-sensitive hash function. The similarity can then be established in relation to another key in the image space of this function. The function can be selected here so that similar marking features result in neighboring hash values. Neighboring in this case means that the distance between two hash values in the metric space of the image of the hash function is not greater than a predefined value. A hash function is determined that meets these properties. It can be obtained by suitably selected training data containing the extracted marking element features of identical and differing markings, for example data matrix codes, under variable conditions of capture. Variable conditions for the capture of the image(s) include, inter alia, different perspective distortions, variable exposures and/or defects in the marking or partial imaging of the code. The thus obtained hash function can be used with previously defined error bounds for a robust recognition of the code. If the image of a marking does not fall within the predetermined neighbourhood of another digital identifier in the image space of the hash function, then these two codes are considered to be different.

The following can be provided for tracking the workpiece: capturing a current image showing the marking on the workpiece at least in sections; determining at least one current marking element feature for one or more of the marking elements, wherein to this end digital image data are evaluated for the following image; generating current feature data indicating the at least one current marking element feature; determining a current digital identifier for the workpiece from current marking data comprising the current feature data; and determining whether the current digital identifier matches the digital identifier in the electronic memory. As far as the comparison of the current digital identifier with the digital identifier is concerned, the explanation relating to the comparison of two digital identifiers set out in the foregoing applies accordingly. A method for preparing (electronically registering) and tracking a workpiece is provided this way.

The determination of the current digital identifier can be carried out, for example, after the application of one or more processing steps to the workpiece, whether during an ongoing production or manufacturing process or after its completion. The current digital identifier can also optionally be determined while taking into account the marking content and/or one or more workpiece features. The current digital identifier can be utilized for any desired application purpose, such as requesting access to workpiece data associated with the workpiece in an electronic database at any point in time during or after the production or manufacturing process.

Tokens can be generated independently of the workpiece with the token generator. By means the tokens, it is possible to grant access to the workpiece data defined during the generation. Furthermore, it can be defined during the generation of the token whether access to the workpiece data is granted with the token itself or only in combination with the digital identifier. Via the use of a token when writing in the database, the owner of the workpiece data can also selectively restrict access to the workpiece data he or she generates.

The example embodiments explained in the foregoing can be provided accordingly in combination with the electronic database and/or the token.

In embodiments, a method for providing a digital identifier for a workpiece and for tracking the workpiece by the digital identifier during a production and manufacturing process can be provided as explained in the following. In embodiments, the method comprises providing a digital identifier for a workpiece, comprising: providing the workpiece on which a marking comprising marking elements is arranged, which display an optically readable marking content and comprise marking element features formed separately from the marking content; and capturing an image by an imaging device, wherein the image shows the marking at least in sections. The image is captured after the workpiece provided with the marking has been processed according to at least one processing step during a production and manufacturing process. At least one marking element feature is determined for one or more of the marking elements, wherein to this end digital image data is evaluated for the image. Feature data indicating the at least one marking element feature are generated. A digital identifier for the workpiece is further determined from marking data comprising the feature data, and the digital identifier is stored in an electronic memory as an identifier associated with the workpiece. For the tracking of the workpiece during the production and manufacturing process, the following is then provided: capturing a current image showing the marking on the workpiece at least in sections; determining at least one current marking element feature for one or more of the marking elements, wherein to this end digital image data are evaluated for the following image; generating current feature data indicating the at least one current marking element feature; determining a current digital identifier for the workpiece from current marking data comprising the current feature data; and determining whether the current digital identifier matches the digital identifier in the electronic memory.

The digital identifier can be determined and stored multiple times for the workpiece during the production and manufacturing process. During a new determination of the digital identifier, the digital identifier determined on this occasion can be compared with a previously determined digital identifier and, at the same time, it can be checked whether the marking on the workpiece still possesses an identification effect to a sufficient degree and was not damaged during processing of the workpiece in such a manner that the digital identifier can no longer be determined correctly. The processing step can comprise a hot working step for the workpiece.

The workpiece is tracked here within the scope of a production and manufacturing process by a digital identifier. It is provided that in this variant an image of the marking previously applied to the workpiece is captured (only) after the workpiece provided with the marking has undergone at least one processing step during the production and manufacturing process. The digital identifier for the workpiece is determined from the image, wherein the digital identifier indicates at least one marking element feature for the marking by feature data. The marking element relates to a characteristic of a marking element of the marking and, in this respect, to a characteristic that is different from the optically readable marking content of the marking on the workpiece. This characteristic of the marking element of the marking (digital identifier) is determined and ascertained after the workpiece has previously undergone processing within the scope of a processing step. This thus allows marking element features to be used for the digital identifier that may only have emerged on the marking as a result of the processing step. Marking element features already present on the marking element can, however, also form the basis for the digital identifier. In any case, the image of the marking on the workpiece is only captured after the processing step, so that the digital identifier indicates a state of the marking element on the workpiece after the processing step with respect to the at least one marking element feature.

The workpiece is then tracked during the production and manufacturing process, wherein concurrently—i.e., in the course of the production and manufacturing process—a (further) current image of the marking on the workpiece is captured in order to determine current marking element features and therefrom finally a current digital identifier for the workpiece, in order to compare the current digital identifier with the previously determined and stored digital identifier so that it can be established whether the compared digital identifiers match. Via such comparisons of the (original) digital identifier with current digital identifiers, the workpiece can be tracked through the production and manufacturing process.

### BRIEF DESCRIPTION

Some of the embodiments will be described in detail, with references to the following Figures, wherein like designations denote like members, wherein:

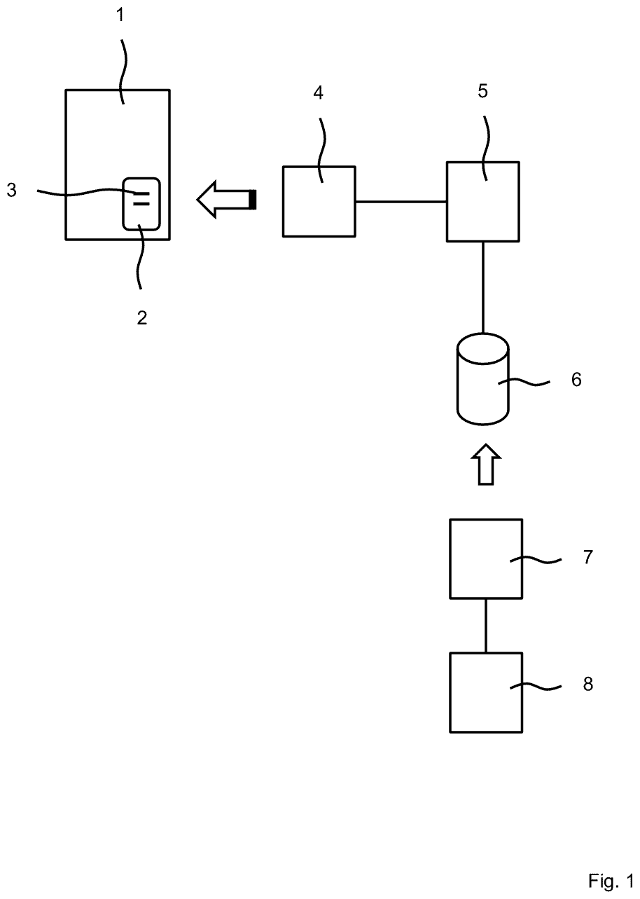

FIG. 1 shows a schematic illustration of components or elements for carrying out a method for electronically registering and tracking a workpiece;

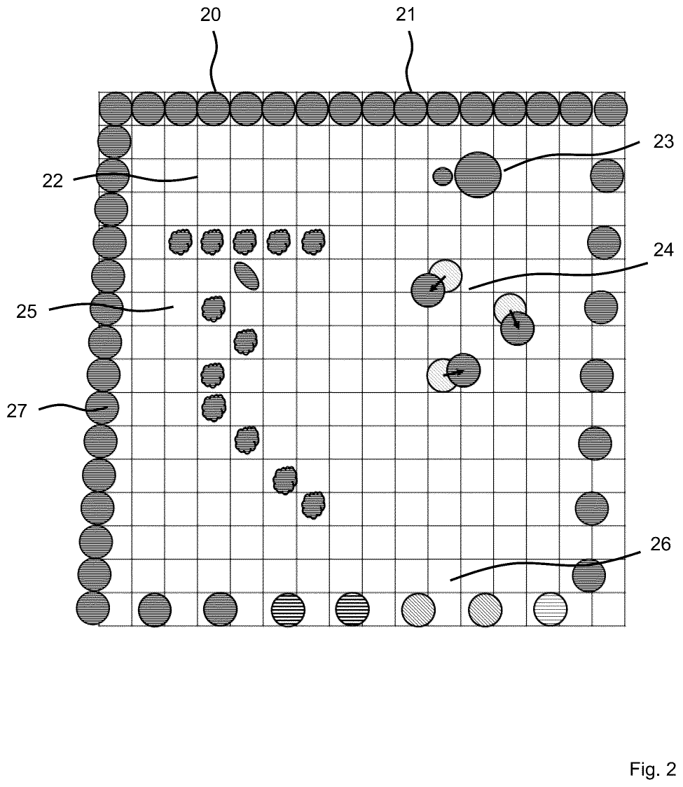

FIG. 2 shows a schematic illustration of an example of a data matrix code in which marking elements are implemented as dots; and

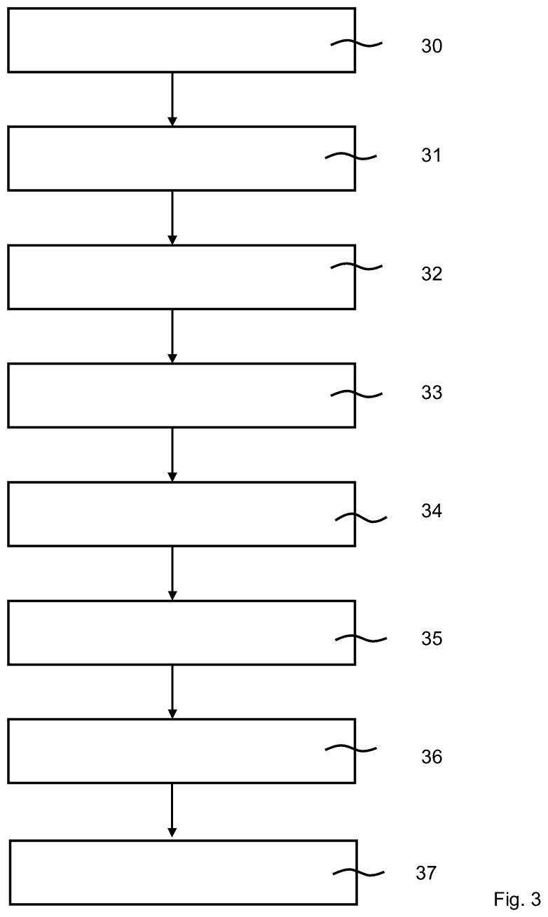

FIG. 3 shows a schematic illustration of the sequence of a method for electronically registering and tracking a workpiece.

### DETAILED DESCRIPTION

FIG. 1 shows a schematic illustration of an arrangement with components or elements for carrying out a method for providing a digital identifier for a workpiece 1. The workpiece 1 comprises a marking 2 with marking elements 3, which can be formed, for example, as lines and/or dots and by which an optically readable marking content is provided.

By an imaging device 4, images or pictures of the workpiece 2 can be captured with and without the marking 2. Digital image data can then be provided for one or more captured images in order to evaluate the digital image data within the scope of an image analysis by a data processing device 5. The data processing device 5 comprises one or more processors and a storage device for this purpose. The processors are configured to perform at least a digital image analysis. The data processing device 5 is connected to an electronic memory 6, which can comprise, for example, an electronic database.

The workpiece 1 can undergo one or more processing steps during a production or manufacturing process. For example, it can be a metal workpiece that is processed by metalworking. It can be provided in this connection that the workpiece 1 is also heated or tempered during the processing. The marking 2 can thus be designed as a marking that is durable even during such processing steps, for example in a hot working, as described for example in the document DE 10 2015 107 774 A1.

FIG. 2 shows an example embodiment for the marking 2, which here comprises a data matrix code 20. The marking elements 3 of the data matrix code 20 are formed here as dots 21. The dots 21, which are also called modules in combination with a data matrix code, are meant to be applied on the workpiece 1 according to a specified matrix 22.

According to FIG. 2, some of the dots 21 exhibit deviations from such target specifications. These include, for example, a deviation of the dot size 23, a deviation of the dot position 24, a deviation of the dot shape 25, a contrast modulation 26 as well as grid irregularities 27. These can be random defects or deviations, or defects or deviations optionally systematically caused by the device for producing the data matrix code 20. Despite these deviations, the optically readable marking content of the marking 2 can still be read out and evaluated. The deviations then lie within possible error tolerances for producing the marking 2 on the workpiece 1. The deviations form error features that can be used to generate a digital identifier for the workpiece 1, which is explained further in the following.

With reference to FIG. 3, a method for providing and for selectively using a digital identifier for the workpiece 1 is described in the following. In step 30, the workpiece 1 is provided with the marking 2 (also identification or mark) arranged on the same. By the imaging device 4, which comprises for example a camera, one or more images or pictures are captured which at least partially capture the marking 2 (step 31).

By the data processing device 5, digital image data for the images are evaluated within the scope of an image analysis (step 32). During this analysis, in step 33, one or more marking element features are determined for the marking elements 3 of the marking 2, in particular one or more of the deviations determined previously in conjunction with FIG. 2, in order to then provide, in step 34, feature data indicating the one or more marking element features extracted in the scope of the image analysis.

Based on marking data comprising the feature data, a digital identifier for the workpiece 1 is determined by the data processing device 5 in step 36 in order to store the digital identifier assigned to the workpiece 1 in the electronic memory 6 in step 37. This way, a unique electronic ID (digital identifier) is provided for the workpiece 1, which can be used in any desired application to identify and track the workpiece 1. It thereby becomes possible, for example, to allow users who are in possession of the digital identifier to access workpiece data that is stored associated with the digital identifier and thus with the workpiece 1 in the electronic memory 6.

If a user wants to access the workpiece data via a user interface 7 with an input device 8 (cf. FIG. 1), he or she must provide the digital identifier as a kind of token, whereupon it can be checked whether this token corresponds to the digital identifier for the workpiece 1 previously stored in the electronic memory 6. The user is only granted access to the workpiece data if the request identifier transmitted as part of the request for access matches the stored digital identifier, at least within a certain specified error tolerance. Otherwise, the access of the user to the workpiece data in the electronic memory 6 is blocked.

In alternative embodiments, it can be provided to supplement the marking data from which the digital identifier is calculated or determined with content data which at least partially indicates the optically readable marking content of the marking 2. Alternatively or additionally, it can be provided to supplement the marking data with workpiece feature data which indicates for the workpiece 1 at least one workpiece feature previously determined for the workpiece 1 in an area outside the marking 2, for example a surface structure or surface contour in the area of the workpiece 1. The workpiece feature can also be determined in the scope of the image analysis of the digital image data.

Further aspects are explained in the following.

The workpiece is first marked with a method suitable for the field of application in order to provide the marking 2 on the workpiece 1. In particular ink printing, laser engraving, needle embossing, labels or a combination of multiple methods are conceivable here. The marking 2 is firmly attached to the surface either directly or during further production steps and is thus permanently deposited on the workpiece 2. The permanent adhesion of the marking 2 can be realized, for example but not exclusively, using certain material pigments in an ink or paste.

An image of the marking 2 can now be captured with the imaging device 4 directly after the marking of the workpiece 1 and optionally additionally after the next process step (for example a hot working step) and passed to the data processing device 5 for further processing.

Unique features are extracted from the image of the present marking 2, which features can be robustly recognized even under, within limits, variable surrounding conditions. In addition to the surrounding conditions, robustness relates to an error tolerance that allows an unambiguous identification even in the event of a permissible number of defects (scratches, dirt, etc.). The digital identifier is then determined by these features, for example as a unique hash value of the marking data. The uniqueness here relates to the set of all possible hash values and is intended to ensure that each hash value occurs only once (avoidance of collisions), so that the digital identifier can always be unambiguously matched with a workpiece. The hash value acts as a key and key value (ID) for a data storage in which workpiece information can be matched with the workpiece in an unambiguous manner. The data storage here can be a private cloud storage or a distributed storage (distributed ledger, DLT). In the case of a private cloud storage, so-called connectors can be implemented in order to establish an interface between the different data silos of different users.

To generate the checksums (hash value), it is possible to use a hash function that is not publicly available in order to prevent an access without a workpiece or other key. The workpiece 1 itself, more precisely its marking 2, thus acts as an optical key (identifier) for the data storage.

All data that have been written in the data storage using only the digital identifier can be viewed by anyone in possession of the workpiece 1 and thus of the marking 2. Moreover, data can be protected and selectively shared by additional private tokens. The tokens are acquired from a token generator and can be traded so that the disposition of the tokens can be specifically linked to certain read and write rights for certain data.

All workpiece data can also be stored in encrypted form in a distributed platform (distributed ledger, DLT). As a distributed memory, the platform offers redundancy and thus protection against data loss. Changes to the data set must be confirmed by multiple parties (consensus), so that a protection against manipulation is ensured. By using open standards, the platform can be connected to existing data memories and stored data can be shared autonomously by tokens (smart contracts).

Via homomorphic encryption methods, existing data records pertaining to the workpiece 1 can be relayed in encrypted form to third parties (service providers), who can, for example, apply their own algorithms to the encrypted data and feed the results back in. A compensation occurs here via the later use of the results. The data are in turn traded using previously generated and acquired tokens.

Although the invention has been illustrated and described in greater detail with reference to the exemplary embodiment, the invention is not limited to the examples disclosed, and further variations can be inferred by a person skilled in the conventional art, without departing from the scope of protection of the invention.

For the sake of clarity, it is to be understood that the use of “a” or “an” throughout this application does not exclude a plurality, and “comprising” does not exclude other steps or elements.

1. A method for providing a digital identifier for a workpiece, comprising:
providing a workpiece on which a marking including marking elements is arranged, which
display an optically readable marking content, and
includes marking element features formed separately from the marking content;
capturing an image by an imaging device, wherein the image shows the marking at least in sections;
determining at least one marking element feature for one or more of the marking elements, wherein to this end digital image data are evaluated for the image;
generating feature data indicating the at least one marking element feature;
determining a digital identifier for the workpiece from marking data including the feature data; and
storing the digital identifier as an identifier associated with the workpiece in an electronic memory.

2. The method according to claim 1, wherein during the determining of the at least one marking element feature, an error feature is determined, which is an actual feature that deviates from a target feature for the one or more marking elements.

3. The method according to claim 2, wherein the error feature indicates at least one deviation from the following group:
deviation of a marking element position from a target position;
deviation of a marking element shape from a target shape;
deviation of a marking element size from a target size;
deviation of a marking element brightness from a target brightness;
deviation of a marking element contrast from a target contrast;
deviation of a marking element spacing from a target spacing; and
deviation of a relative marking element position in relation to another marking element and/or an arrangement grid from a relative target position.

4. The method according to claim 1, wherein the digital identifier is determined as a checksum of the marking data.

5. The method according to claim 4, wherein the checksum is determined as a hash value of the marking data.

6. The method according to claim 1, wherein the digital identifier for the workpiece is determined from marking data including content data that at least partially indicate the optically readable marking content.

7. The method according to claim 1, wherein the following is further provided:
determining at least one workpiece feature for an area outside the marking on the workpiece, wherein to this end the digital image data for the image and/or further digital image data for a further image are evaluated;
generating workpiece feature data that indicate the at least one workpiece feature; and
determining the digital identifier for the workpiece from marking data including the workpiece feature data.

8. The method according to claim 1, wherein a workpiece from the following group is provided as the workpiece: blank, processed blank, component, component group, metal component, processed component, processed component group, processed metal component, semi-finished material, semi-finished product, sub-assemblies, assembly group, assembly part, moulding, finished component, and finished assembly.

9. The method according to claim 1, wherein the image is captured after the workpiece provided with the marking has been processed according to at least one processing step.

10. The method according to claim 1, wherein a workpiece is provided with a marking including a data matrix code, wherein modules of the data matrix code form the marking elements.

11. The method according to claim 1, wherein the provision of the workpiece includes an application of the marking to the workpiece, wherein the marking elements are produced using at least one marking method from the following group: ink printing, laser engraving, needle embossing, applying a label, applying marker elements such as magnetic particles, emitting particles or the like, mechanical engraving, stamping processes, screen printing, coatings, and plotting.

12. The method according to claim 1, wherein
storing workpiece data associated with the digital identifier for the workpiece in the electronic memory;
receiving a request to access the workpiece data in an access device capable of accessing data in the electronic memory, wherein indicator data indicating a digital request identifier are received with the request;
checking whether the digital request identifier matches the digital indicator; and
granting the requested access to the workpiece data if it is established that the digital request identifier matches the digital identifier within a specified error tolerance.

13. The method according to claim 1, wherein the following is provided for tracking the workpiece:
capturing a current image showing the marking on the workpiece at least in sections;
determining at least one current marking element feature for one or more of the marking elements, wherein to this end digital image data are evaluated for the following image;
generating current feature data indicating the at least one current marking element feature;
determining a current digital identifier for the workpiece from current marking data including the current feature data; and
determining whether the current digital identifier matches the digital identifier in the electronic memory.

14. An electronic database for electronically registering and tracking workpieces, including digital identifiers that are electronically stored in a database storage element, are respectively stored associated with a workpiece, and have been determined in accordance with a method according to claim 1.

15. A token, comprising a digital identifier associated with a workpiece and determined in accordance with a method according to claim 1.

16. A device for generating a token, comprising one or more processors that are configured to generate a token according to claim 15.
